(19) United States
(12) Patent Application Publication
(10) Pub. No.: US 2015/0147548 A1
(43) Pub. Date: May 28, 2015

(54) FOIL FOR LABELS AND COVER MEMBRANES

(71) Applicant: Huhtamaki Films Germany GmbH & Co., KG, Forchheim (DE)

(72) Inventors: Matthias MAUSER, Hausen (DE); Michael SCHUHMANN, Grosshabersdorf (DE)

(73) Assignee: HUHTAMAKI FILMS GERMANY GMBH & CO. KG, Forchheim (DE)

(21) Appl. No.: 14/189,935

(22) Filed: Feb. 25, 2014

(30) Foreign Application Priority Data
Nov. 27, 2013 (DE) 102013113120.4

(51) Int. Cl. C09J 7/02; C08L 53/00; B32B 27/08; C08F 293/00

(52) U.S. Cl. CPC C09J 7/02; C08F 293/00; C08L 53/00; B32B 27/08
USPC 428/220; 525/324; 525/88; 428/516; 428/523; 428/476.9; 428/474.4; 428/339; 428/354

(57) ABSTRACT

The invention relates to a foil having at least one first layer (1) comprising at least 50% of random heterophasic polypropylene (block) copolymer. The invention further relates to labels and cover membranes comprising the foil.

### CROSS-REFERENCE TO RELATED APPLICATION

The present application claims priority to German Patent Application No. 102013113120.4, filed on Nov. 27, 2013, which is hereby incorporated by reference in its entirety for all purposes.

### DESCRIPTION

The present invention relates to a foil for labels and cover membranes that is dimensionally stable under one-sided heat treatment.

For applications involving one-sided heat treatment, the foils used in the prior art are generally PVC foils, since these do not exhibit a curling effect. A problem with PVC foils, however, is their poor recyclability.

Known from publication DE 10246864 A1 is a PVC-free cover membrane composed of a foil/bitumen composite comprising two foil layers having different coefficients of thermal expansion for the purpose of preventing the curling effect.

It is an object of the present invention to provide a foil which is recyclable, inexpensive, and comparable in its performance with a PVC foil. A further object is to provide labels and cover membranes comprising the foil.

The above object is achieved by means of a foil having at least one first layer comprising at least 50 wt % of random heterophasic polypropylene (block) copolymer.

Random heterophasic polypropylene (block) copolymer (or “r-PP-HeCo” for short) consists of a homogeneous phase of polypropylene with small amounts of ethylene and butene in random (block) distribution. This continuous phase provides rigidity and heat resistance. The second phase is a finely divided phase of ethylene-propylene rubber, a random copolymer of ethylene and propylene in which ethylene is predominant. This phase ensures internal cushioning and elasticity, thereby improving the impact strength and tear resistance. Both phases are prepared in situ in the reactor, in a sequential polymerization process with the aid of Ziegler-Natta or metallocene catalysts.

The first layer preferably comprises a further polypropylene polymer or polypropylene copolymer.

In a preferred embodiment, the foil comprises a second layer of polypropylene polymer or polypropylene copolymer.

In an alternative preferred embodiment, the foil comprises as a second layer a barrier layer that is impervious to mineral oils. The barrier layer may comprise polyamide (co)polymer, a polyamide alloy, PET, O-PET or a coating material. The barrier layer preferably comprises polyamide copolymer.

In the alternative preferred embodiment, the foil preferably has an adhesion-promoting layer between the first and second layers. The adhesion-promoting layer preferably comprises an adhesion-promoting polymer. With more particular preference this polymer is a modified polypropylene. Use may be made, for example, of a polypropylene modified with maleic anhydride groups.

With further preference the foil is of symmetrical construction, with the second layer being followed again by an adhesion-promoting layer and then by a layer which corresponds in composition to the first layer.

The thickness of the first layer is preferably at least 5 μm, more preferably 10 μm, very preferably 15 μm, especially preferably 20 μm.

The total thickness of the foil is preferably at least 20 μm, more preferably at least 40 μm, especially preferably at least 60 μm, and most preferably at least 75 μm.

In a second aspect, the present invention relates to a label comprising the foil according to any of claims 1 to 3, pressure-sensitive adhesive and paper. The label preferably comprises the following 4 layers in the stated order: a first layer comprising at least 50 wt % of random heterophasic polypropylene (block) copolymer, a second layer of polypropylene polymer or polypropylene copolymer, a third layer of pressure-sensitive adhesive, and a fourth layer of paper.

In a third aspect of the invention, the present invention relates to a cover membrane comprising a foil according to any of claims 4 to 7 and also an adhesive. The cover membrane preferably comprises the following 6 layers in the stated order: a first layer comprising at least 50 wt % of random heterophasic polypropylene (block) copolymer, a second layer comprising an adhesion promoter, a third layer of polyamide, a fourth layer comprising an adhesion promoter, a fifth layer corresponding to the first layer, and a sixth layer comprising an adhesive. The adhesive is preferably bitumen or polybitumen. The adhesive is advantageously protected with a release foil or release paper as a further layer, which may be removed during the application.

FIG. 1 shows a preferred embodiment of a foil with two layers.

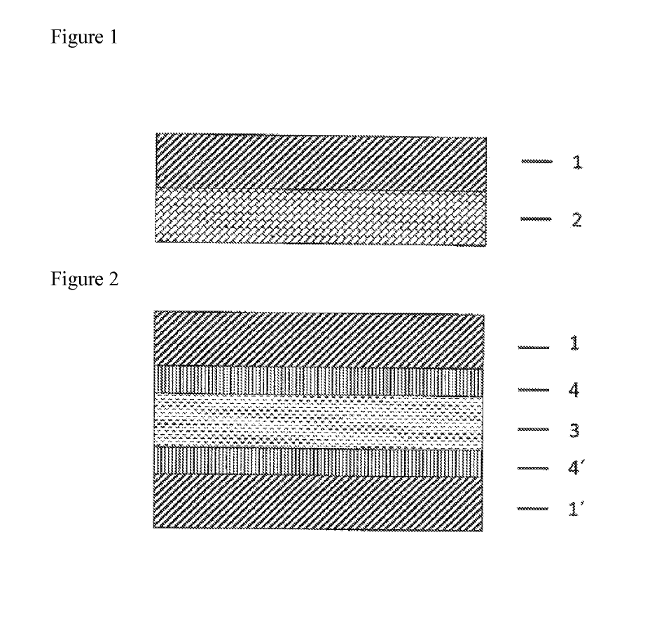

FIG. 2 shows a preferred embodiment of a foil with five layers.

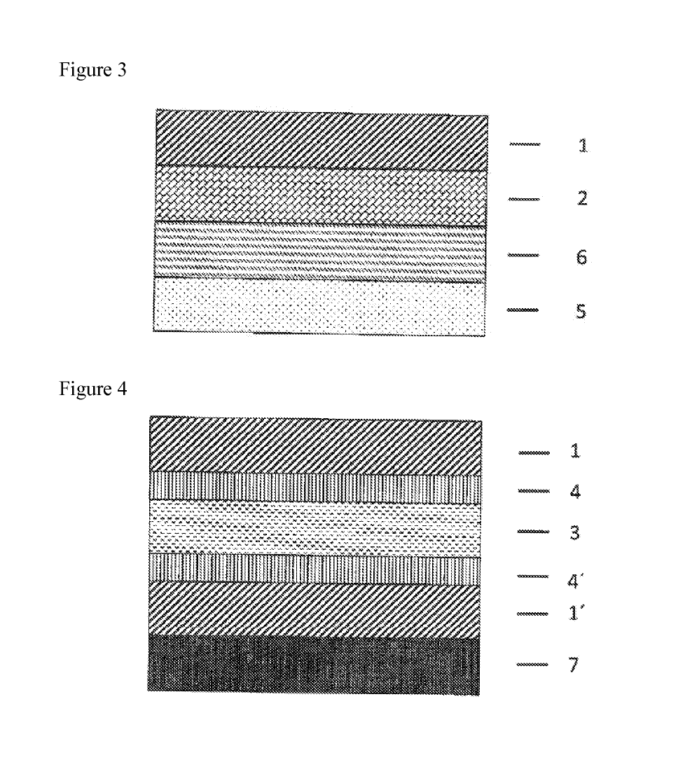

FIG. 3 shows a preferred embodiment of a label.

FIG. 4 shows a preferred embodiment of a cover membrane.

FIG. 1 shows a foil having at least one first layer (1) comprising a mixture of 50 wt % of heterophasic random polypropylene (block) copolymer and heterophasic polypropylene copolymer. The second layer (2) of the foil consists of polypropylene.

The blend of heterophasic polypropylene (block) copolymer and at least 50 wt % of random polypropylene heterophasic (block) copolymer minimizes crystallization effects, such as recrystallization of polypropylene, and prevents shrinkage effects in response to temperatures acting in each case at one side, and a one-sided curling on the temperature-exposed side. In order to achieve stable processability, coating or printing takes place preferably below the melting point of all the polymers.

It has emerged that the sole use of random polypropylene (r-PP) for a foil produced by the film-blowing or film-casting process causes excessive shrinking and curling effects in applications where temperatures act on one side, owing to the molecular orientation resulting from the production process.

In contrast, curling effects and excessive shrinking effects can be prevented by the use of heterophasic random polypropylene copolymer alone or as a blend of at least 50 wt % of heterophasic random polypropylene copolymer with a further polypropylene polymer or polypropylene copolymer, as present in layer 1 in FIG. 1.

FIG. 2 shows a further preferred embodiment of the foil of the invention. The foil is designed as an assembly of five layers. Layer 1 corresponds to the layer in the first embodiment. It is followed by an adhesion promotion layer 4. Provided thereon is a barrier layer 3 which prevents the migration of mineral oils. The barrier layer 3 may consist, for example, of a polyamide, a polyamide alloy, PET, O-PET or a coating material. It is followed by layers 4′ and 1′, corresponding to layers 4 and 1, thus producing overall a symmetrical construction. An alternative possibility is a foil assembly composed of layers 1, 4 and 3.

FIG. 3 shows the preferred embodiment of a label. The label consists of the foil assembly shown in FIG. 1, with a pressure-sensitive adhesive layer 6 applied to the polypropylene layer 2, and a paper carrier 5, preferably made of non-shrinking paper, applied to the layer 6.

FIG. 4 shows a preferred embodiment of a cover membrane or coversheet. The cover membrane consists of the foil assembly shown in FIG. 2, composed of layers 1, 4, 3, 4′ and 1′, with a layer of bitumen applied to layer 1′. In addition, an anti-slip coating may be applied to the top face of the cover membrane. The cover membrane is suitable more particularly for the sealing of roof areas. An alternative possibility is the use of a cover membrane comprising layers 7, 1, 4 and 3. In both alternatives, the tacky substance is advantageously protected with a release foil or release paper, which is removed during the application.

### EXAMPLES

### Use Example 1

Label Foil for Laser Printer

A laser printer was used to print on the paper side of a label constructed as in FIG. 3. In this printing procedure, the surface of the foil was heated briefly at 130 to 135° C. (time: <1 s). In spite of the difference in heating and cooling of the side exposed directly to the temperature and the side facing away from the temperature exposure, it was possible to prevent any curling effect.

### Use Example 2

During the application of bitumen in the production of a cover membrane constructed as in FIG. 4, there is different heating and cooling, during the cooling operation, of the side exposed directly to the temperature and the side facing away from the temperature exposure.

The difference in temperature exposure occurs in particular as a result of the customary counter-cooling during or after the application of bitumen. In this counter-cooling procedure, the foil is cooled from one side, while bitumen is coated onto the opposite side. This takes place at 160° C. to 170° C. in the case of direct coating, and at up to 140° C. in the case of indirect coating. In spite of the one-sided temperature exposure, it was possible to prevent the curling effect.

For an evaluation of the curling effect, moreover, the following examples were evaluated:

The raw materials used in the examples were as follows:
r-PP HeCo random polypropylene heterophasic (block) copolymer from Lyondell Basell
PP HeCo polypropylene heterophasic (block) copolymer from Prasken (ethylene fraction 7% to 9%)
adhesion-polypropylene modified with maleic anhydride promoting groups, from Mitsui polymer
CoPA copolyamide formed from ε-caprolactam-isophoronediamine and isoterephthalic acid, having an isophoronediamine fraction of around 5%, from Lanxess
r-PP random polypropylene copolymer from Lyondell Basell (ethylene fraction 2% to 4%)

### Example 1

A foil was produced from a layer consisting of 100% r-PP HeCo, with a layer thickness of 80 μm.

### Example 2

A foil was produced from a layer of 50% r-PP HeCo and 50% PP HeCo, with a layer thickness of 80 μm.

### Example 3

A foil was produced from two layers. The first layer consisted of r-PP HeCo (50%) and PP HeCo (50%), with a layer thickness of 20 μm. The second layer consisted of 100% PP HeCo, with a layer thickness of 60 μm.

### Example 4

A foil was produced from three layers. The first layer consisted of r-PP HeCo (50%) and PP HeCo (50%), and had a layer thickness of 44 μm. The second layer consisted of adhesion-promoting polymer (100%), with a layer thickness of 6 μm. The third layer consisted of CoPA (100%), with a layer thickness of 25 μm.

### Example 5

A foil was produced from five layers. The first layer consisted of r-PP HeCo (50%) and PP HeCo (50%), with a layer thickness of 44 μm. The second layer consisted of adhesion-promoting polymer (100%), with a layer thickness of 6 μm. The third layer consisted of CoPA (100%), with a layer thickness of 25 μm. The fourth layer consisted of adhesion-promoting polymer (100%), with a layer thickness of 6 μm. The fifth layer consisted of r-PP HeCo (50%) and PP HeCo (50%), with a layer thickness of 44 μm.

Furthermore, the following comparative examples were produced.

### Comparative Example 1

A film was produced from a layer consisting of 50% r-PP and 50% PP HeCo, with a layer thickness of 80 μm.

### Comparative Example 2

A film was produced from two layers. The first layer consisted of 50% r-PP and PP HeCo (50%), with a layer thickness of 20 μm. The second layer consisted of PP HeCo (100%), with a layer thickness of 60 μm.

### Comparative Example 3

A film was produced from a layer consisting of 100% PP HeCo, with a layer thickness of 80 μm.

The inventive and comparative examples were evaluated as follows:

The foils were affixed to a paper carrier (shrinkage at 110° C. for 30 s<1%) using a self-adhesive composition (adhesive tape from 3M) and printed using a laser printer (HP; model 1320n). The operation of fixing the ink particles on the foil in the laser printer has a temperature of 130 to 135° C. and a duration of 0.5 to 1 s.

Curling is determined using the following evaluation scale:
++=no curling;
+=little curling;
−=severe curling;
−−=very severe curling

The results are shown in Table 1.

TABLE 1

| Foil examples | Curling |
|---|---|
| Example 1 | ++ |
| Example 2 | ++ |
| Example 3 | + |
| Comparative Example 1 | − |
| Comparative Example 2 | − |
| Comparative Example 3 | −− |

### List of Reference Numerals

1 first layer, comprising at least 50 wt % of random heterophasic polypropylene (block) copolymer (e.g. 50% r-PP HeCo and 50% PP-HeCo)
2 second layer, comprising polypropylene polymer or polypropylene copolymer (e.g. PP-HeCo)
3 barrier layer impervious to mineral oils (e.g. PA)
4 adhesion-promoting layer
5 paper carrier (preferably non-shrinking)
6 pressure-sensitive adhesive
7 tacky substance (bitumen or self-adhesive sealant)

What is claimed is:

1. Foil with at least one first layer (1) comprising at least 50 wt % of random heterophasic polypropylene (block) copolymer.

2. Foil according to claim 1, the first layer (1) comprising a further polypropylene polymer or polypropylene copolymer.

3. Foil according to claim 1 or 2, the foil comprising a second layer comprising polypropylene polymer or polypropylene copolymer (2).

4. Foil according to claim 1 or 2, the foil comprising as a second layer a barrier layer (3) impervious to mineral oils.

5. Foil according to claim 4, the barrier layer (3) comprising a polyamide copolymer.

6. Foil according to either of claims 4 and 5, the foil comprising an adhesion- promoting layer (4) between layers (1) and (3).

7. Foil according to claim 6, the foil comprising a layer (1′), corresponding in composition to layer (1), and comprising a second adhesion-promoting layer (4′) between layers (3) and (1′).

8. Foil according to any of claims 1 to 7, the thickness of the layer (1) being at least 5 μm.

9. Foil according to any of claims 1 to 7, the total thickness of the foil being at least 20 μm.

10. Label comprising a foil according to any of claims 1 to 3, paper (5) and pressure-sensitive adhesive (6).

11. Cover membrane comprising a foil according to any of claims 4 to 7 and a tacky substance (7).

12. Cover membrane according to claim 11, the tacky substance (7) being bitumen or self-adhesive sealant.
